(19) United States
(12) Patent Application Publication
(10) Pub. No.: US 2011/0310418 A1
(43) Pub. Date: Dec. 22, 2011

(54) INFORMATION PROCESSING SYSTEM, METHOD OF CONTROLLING THE SAME, AND PROGRAM

(75) Inventor: Junichi Miyata, Kawasaki-shi (JP)

(73) Assignee: CANON KABUSHIKI KAISHA, Tokyo (JP)

(21) Appl. No.: 13/107,865

(22) Filed: May 13, 2011

(30) Foreign Application Priority Data
Jun. 18, 2010 (JP) 2010-139942

(51) Int. Cl. G06F 3/12

(52) U.S. Cl. 358/1.13

(57) ABSTRACT

This invention provides an information processing system which dynamically changes, in accordance with the configuration of a connected image processing apparatus, the operation mode when causing the image processing apparatus to execute a job, and a method of controlling the same. To accomplish this, the information processing system according to the invention includes an MFP capable of executing a job script, an MFP that opens the functions of the MFP to the outside so as to allow controlling job execution externally, and a Web server that creates screen data to be displayed on the operation unit of the MFP. In the information processing system, the MFP notifies the Web server of the device configuration information of the MFP, and the Web server determines, based on the device configuration information, the optimum operation mode when causing the MFP to execute a job.

### BACKGROUND OF THE INVENTION

1. Field of the Invention

The present invention relates to an information processing system including a Web server serving as an information processing apparatus and an image processing apparatus having a Web browser that displays an operation screen provided by the Web server, a method of controlling the same, and a program.

2. Description of the Related Art

An information processing apparatus such as a PC is known to be connected to a Web server on a network and display an operation screen provided by the Web server on a Web browser of the information processing apparatus. In this case, the Web browser of the information processing apparatus first requests the operation screen of the Web server. After that, in response to the request from the information processing apparatus, a Web application on the Web server returns, to the information processing apparatus, an HTML file configured to display the operation screen on the Web browser. The Web browser of the information processing apparatus analyzes the received HTML file, and displays the operation screen based on the description of the HTML file. When the user inputs an instruction via the operation screen displayed on the Web browser, the Web browser notifies the Web server of the input instruction. When notified, the Web application on the Web server executes processing in accordance with the input instruction.

Some recent MFPs (Multi Function Peripherals) serving as an image processing apparatus including a scanner and a printer include a Web browser as described above. Such MFPs display an operation screen provided by a Web server using the above-described procedure on the Web browser of the MFP, and accepts various kinds of user instructions.

Japanese Patent Laid-Open No. 2006-127503 proposes a technique of causing a Web server to provide an operation screen to be used to input instructions to use the functions of an MFP. More specifically, the user of the MFP inputs an instruction to the MFP. The Web browser of the MFP notifies the Web server of the input instruction as a request. Upon receiving the notification, the Web server creates a script that describes various kinds of processing for the MFP based on the input instruction. The Web server notifies the MFP of the created script as a response to the above-described request from the Web browser. The MFP executes the script by transferring it from the Web browser to a script processing unit, thereby using the function of the MFP. Japanese Patent Laid-Open No. 2008-003833 proposes a technique of causing a Web browser to execute a screen display script, unlike Japanese Patent Laid-Open No. 2006-127503. More specifically, a Web service that processes a function of an MFP is invoked in the script, thereby using the device function.

However, conventional techniques have the following problem. For example, in a system formed by connecting a plurality of MFPs and Web servers, the optimum system configuration including Web servers changes depending on the configurations of the MFPs. That is, if one system includes a plurality of kinds of MFPs, a plurality of Web servers each having operation modes complying with the configuration of each MFP connected to the Web servers need to be built. This results in an increase in the building cost and management cost of the Web servers.

### SUMMARY OF THE INVENTION

The present invention enables realization of an information processing system which dynamically changes, in accordance with the configuration of a connected image processing apparatus, the operation mode when causing the image processing apparatus to execute a job, and a method of controlling the same.

One aspect of the present invention provides an information processing system including an image processing apparatus and an information processing apparatus which are connected via a network, the image processing apparatus comprising: a generation unit that generates device information representing an operation capability of the image processing apparatus; and a device information transmission unit that transmits the device information generated by the generation unit to the information processing apparatus, and the information processing apparatus comprising: an analyzing unit that analyzes the device information transmitted from the image processing apparatus; and a determination unit that determines, based on an analysis result of the analyzing unit, an operation mode when causing the image processing apparatus to execute a job.

Another aspect of the present invention provides an information processing system including an image processing apparatus and an information processing apparatus which are connected via a network, the image processing apparatus comprising: an analyzing unit that analyzes an operation capability of the image processing apparatus; a determination unit that determines, based on an analysis result of the analyzing unit, an operation mode when executing a job designated by the information processing apparatus; and an operation mode transmission unit that transmits the operation mode determined by the determination unit to the information processing apparatus.

Still another aspect of the present invention provides a method of controlling an information processing system including an image processing apparatus and an information processing apparatus which are connected via a network, comprising: causing a generation unit of the image processing apparatus to generate device information representing an operation capability of the image processing apparatus; causing a device information transmission unit of the image processing apparatus to transmit the device information generated in causing the generation unit of the image processing apparatus to generate the device information to the information processing apparatus; causing an analyzing unit of the information processing apparatus to analyze the device information transmitted from the image processing apparatus; and causing a determination unit of the information processing apparatus to determine, based on an analysis result of causing the analyzing unit of the information processing apparatus to analyze the device information, an operation mode when causing the image processing apparatus to execute a job.

Still yet another aspect of the present invention provides a method of controlling an information processing system including an image processing apparatus and an information processing apparatus which are connected via a network, comprising: causing an analyzing unit of the image processing apparatus to analyze an operation capability of the image processing apparatus; causing a determination unit of the image processing apparatus to determine, based on an analysis result of causing the analyzing unit of the image processing apparatus to analyze the operation capability, an operation mode when executing a job designated by the information processing apparatus; and causing an operation mode transmission unit of the image processing apparatus to transmit the operation mode determined in causing the determination unit of the image processing apparatus to determine the operation mode to the information processing apparatus.

Yet still another aspect of the present invention provides a computer-readable storage medium storing a computer program which causes a computer to execute the information processing system control method.

Further features of the present invention will be apparent from the following description of exemplary embodiments with reference to the attached drawings.

### BRIEF DESCRIPTION OF THE DRAWINGS

FIG. 1 is a view showing an example of the configuration of an information processing system according to the first embodiment;

FIG. 2 is a block diagram showing an example of the arrangements of an MFP 101 or 102 and a Web server 103 according to the first embodiment;

FIG. 3 is a block diagram showing the functional arrangement of the entire information processing system according to the first embodiment;

FIG. 4 is a sequence chart showing an overall processing sequence according to the first embodiment;

FIG. 5 is a sequence chart showing a processing sequence in a script mode according to the first embodiment;

FIG. 6 is a sequence chart showing a processing sequence in a non-script mode according to the first embodiment;

FIG. 7 is a view showing an example of the screen displayed on the MFP;

FIG. 8 is a view showing an example of the job flow execution screen displayed on the MFP;

FIG. 9 is a flowchart showing the processing procedure of the Web server 103 according to the first embodiment;

FIG. 10 is a view showing an example of the end screen displayed on the MFP; and

FIG. 11 is a flowchart showing the processing procedure of a Web server 103 according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

The first embodiment of the present invention will now be described. An information processing system according to this embodiment includes an MFP capable of executing a job script to be described later, an MFP that allows an external device connected to a network to externally control job execution by opening the MFP functions to the device, and a Web server that creates screen data to be displayed on the operation unit of the MFP. In this embodiment, the MFP notifies the Web server of device configuration information (device information), and the Web server causes the MFP to execute a job in an optimum operation mode based on the device configuration information.

<Configuration of Information Processing System>

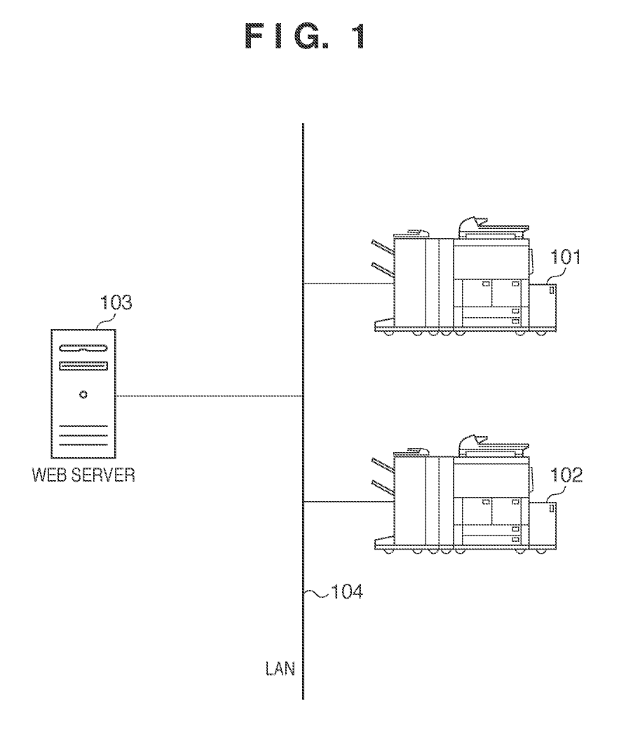

An example of the configuration of the information processing system according to this embodiment will be described first with reference to FIG. 1. As shown in FIG. 1, this information processing system includes MFPs 101 and 102 each serving as an image processing apparatus, and a Web server 103 serving as an information processing apparatus. The apparatuses are connected via a LAN 104 formed from Ethernet® or the like so as to be communicable with each other.

The MFPs 101 and 102 have, for example, a copy function, a scanner function, and a data transmission function. The data transmission function is a function of reading a document image and transmitting image data obtained by reading to an information processing apparatus on the LAN 104 using the FTP protocol, SMB protocol, or the like. It is also possible to create email containing image data as an attached file and transmit the email using an email server (not shown).

The Web server 103 provides an application that runs on the MFPs 101 and 102. In response to a request from the MFP 101 or 102, a Web application that runs on the Web server 103 transmits HTML data to be displayed on the operation unit of the MFP 101 or 102 as a response. In the system of this embodiment, however, the number of constituent devices is not limited to this. Additionally, in this embodiment, the LAN is used as the connection method. However, the present invention is not limited to this. For example, an arbitrary network such as a WAN (public network), a serial transmission scheme such as a USB, a parallel transmission scheme such as centronics or SCSI, or the like is also applicable.

<Arrangements of MFP and Web Server>

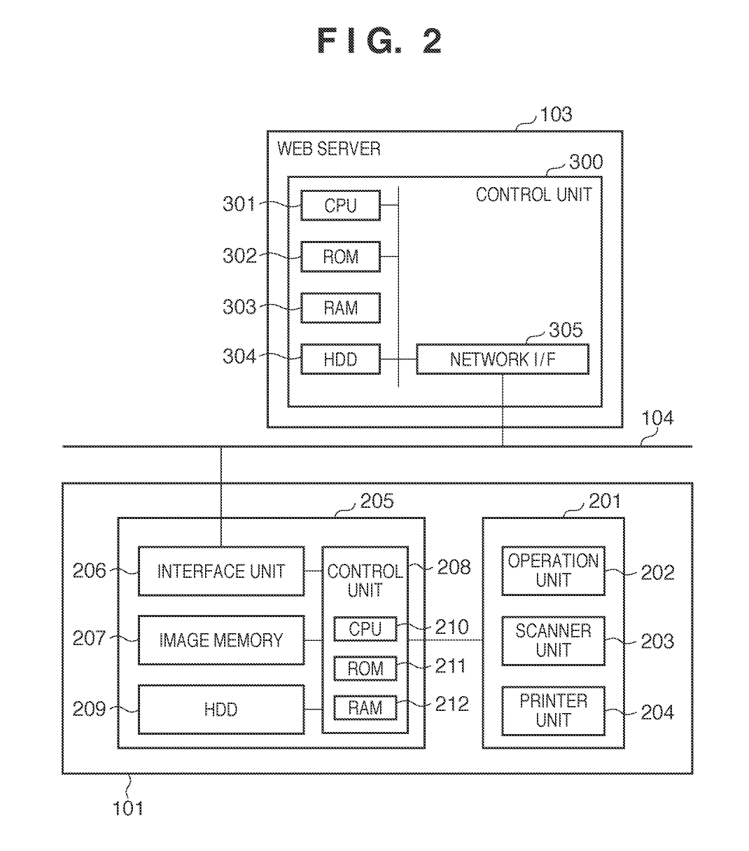

The arrangements of the MFP 101 or 102 and the Web server 103 will be described next with reference to FIG. 2. Although the arrangement of the MFP 101 will be exemplified with reference to FIG. 2, the MFP 102 also has the same arrangement. First, the arrangement of the MFP 101 will be described. A control unit 208 including a CPU 210 generally controls the operation of the MFP 101. The CPU 210 reads out control programs stored in a ROM 211 and executes various kinds of control processing such as reading control and transmission control. A RAM 212 is used as a temporary storage area such as the main memory or work area of the CPU 210. An HDD 209 stores image data and various kinds of programs.

The control unit 208 is connected to a function unit 201 to control the operations of an operation unit 202, a scanner unit 203, and a printer unit 204. The operation unit 202 includes a liquid crystal display unit having a touch panel function and a keyboard. The operation unit 202 also has a Web browser function to be described later. The Web browser analyzes an HTML file received from the Web server 103 and displays, on the operation unit 202, an operation screen based on the description of the received HTML file.

The printer unit 204 prints, on a printing medium, print image data input from the control unit 208. The scanner unit 203 generates image data by reading an image on a document and inputs the generated image data to the control unit 208. An interface unit 206 connects the control unit 208 to the LAN 104 to transmit/receive screen data and the like to be displayed on the operation unit 202. Note that the image read by the scanner unit 203 is temporarily stored in an image memory 207 and transmitted to an information processing apparatus (not shown) via the interface unit 206 under the control of the control unit 208.

The arrangement of the Web server 103 will be described next. A control unit 300 including a CPU 301 generally controls the operation of the Web server 103. The CPU 301 reads out control programs stored in a ROM 302 and executes various kinds of control processing. A RAM 303 is used as a temporary storage area such as the main memory or work area of the CPU 301. An HDD 304 stores various kinds of data and various kinds of programs. A network I/F 305 connects the control unit 300 to the LAN 104.

<Functional Arrangement>

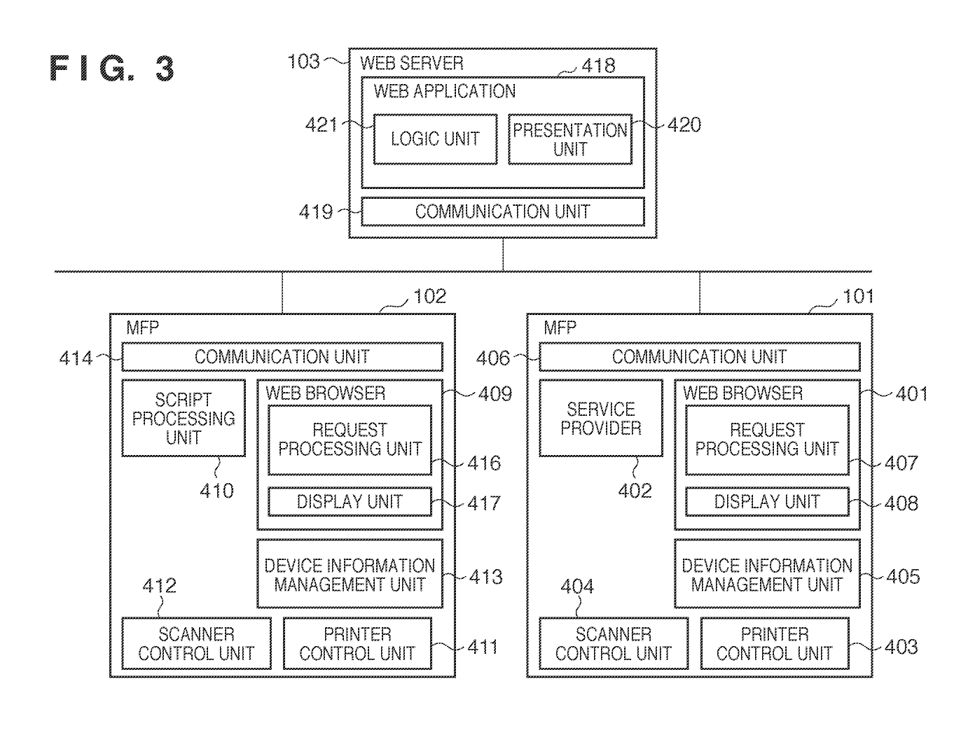

The functional arrangement of the entire information processing system will be described next with reference to FIG. 3. The MFPs 101 and 102 and the Web server 103 correspond to those shown in FIG. 1, respectively. Note that the functions shown in FIG. 3 are implemented by causing the CPUs of the MFPs and the Web server shown in FIG. 2 to execute control programs.

The MFP 101 includes a Web browser 401, a service provider 402, a printer control unit 403, a scanner control unit 404, a device information management unit 405, and a communication unit 406. The Web browser 401 includes a request processing unit 407 and a display unit 408. The request processing unit 407 requests, of the Web server 103, screen information to be displayed on the display unit 408 in accordance with the HTTP protocol. The request processing unit 407 also analyzes an HTML file received from the Web server 103. The HTML file contains a description representing the contents of the operation screen to be displayed on the Web browser. The display unit 408 displays the operation screen on the operation unit 202 of the MFP 101 based on the result of a screen information analysis by the request processing unit 407.

The service provider 402 opens the functions in the MFP 101 to the Web server 103 on the network as an external interface. The functions opened to the public are those of the scanner control unit 404 or the printer control unit 403. The scanner control unit 404 has, for example, a function of controlling the scanner unit 203 to read a paper document, convert it into electronic data, and transmit the data to another information processing apparatus. The printer control unit 403 has a function of controlling the printer unit 204 to output print data to a paper medium. The device information management unit 405 manages the device configuration information of the MFP 101 to be described later. The communication unit 406 performs communication processing such as TCP/IP connection when communicating with the Web server 103.

The MFP 102 includes a Web browser 409, a script processing unit 410, a printer control unit 411, a scanner control unit 412, a device information management unit 413, and a communication unit 414. The Web browser 409 includes a request processing unit 416 and a display unit 417. In accordance with the HTTP protocol, the request processing unit 416 requests screen information to be displayed on the display unit 417 of the Web server 103 via the communication unit 414. The request processing unit 416 also analyzes an HTML file received from the Web server 103. The HTML file contains a description representing the contents of the operation screen to be displayed on the Web browser. The display unit 417 displays the operation screen on the operation unit 202 of the MFP based on the result of the screen information analysis by the request processing unit 416.

The script processing unit 410 analyzes job script information to be described later and executes a scan job, a print job, and the like in the order designated by the script. The script is generated by the Web server 103. The script also defines the processing procedure of a job that executes one or more functions in the MFP. Hence, job execution by the script includes commands to request the scanner control unit 412 to scan a paper document and the printer control unit 411 to print the data into a paper document. For example, to execute a scan job, the scanner control unit 412 controls the scanner unit 203 to read a paper document and store the image data in the HDD 209. To execute a transmission job, the scanner control unit 412 transmits image data in the HDD 209 via the communication unit 414. The device information management unit 413 manages the device configuration information of the MFP 102 to be described later.

The Web server 103 includes a Web application 418 and a communication unit 419. The Web application 418 includes a presentation unit 420 and a logic unit 421. The presentation unit 420 generates and transmits operation screen information to be displayed on the Web browser in response to a request from the Web browser of the MFP 101 or 102.

The Web server 103 also receives a user instruction input via the operation screen displayed on the Web browser of the MFP 101 or 102. Upon receiving the user instruction, the Web application 418 can execute various kinds of processing in accordance with the contents of the instruction or request the service provider 402 of the MFP 101 to execute processing. More specifically, the Web application can request to execute, for example, print processing by the printer control unit 403 of the MFP 101, paper document reading processing by the scanner control unit 404, or transmission processing to a file server on the LAN 104. To request the MFP 101 to execute processing, the logic unit 421 requests the service provider 402 provided in the MFP 101 to perform the various kinds of processing.

The Web application 418 can also generate a job script that describes the sequence of a job to be executed in the MFP 102 and transmit the job script to the Web browser of the MFP 102 in accordance with the contents of the instruction. More specifically, the Web application generates and transmits a job script that describes, for example, requesting execution of print processing by the printer control unit 411 of the MFP 102, execution of paper document reading processing by the scanner control unit 412, or execution of transmission processing to a file server on the LAN 104. To request the MFP 102 to execute processing, the logic unit 421 generates the job script and transmits it to the Web browser 409 provided in the MFP 102.

Note that the processing sequence of job execution to be performed by the above-described MFP 102 using a job script will be referred to as a “script mode”, and the processing sequence of job execution to be performed by the MFP 101 using an external interface will be referred to as a “non-script mode” hereinafter.

<Processing Sequence>

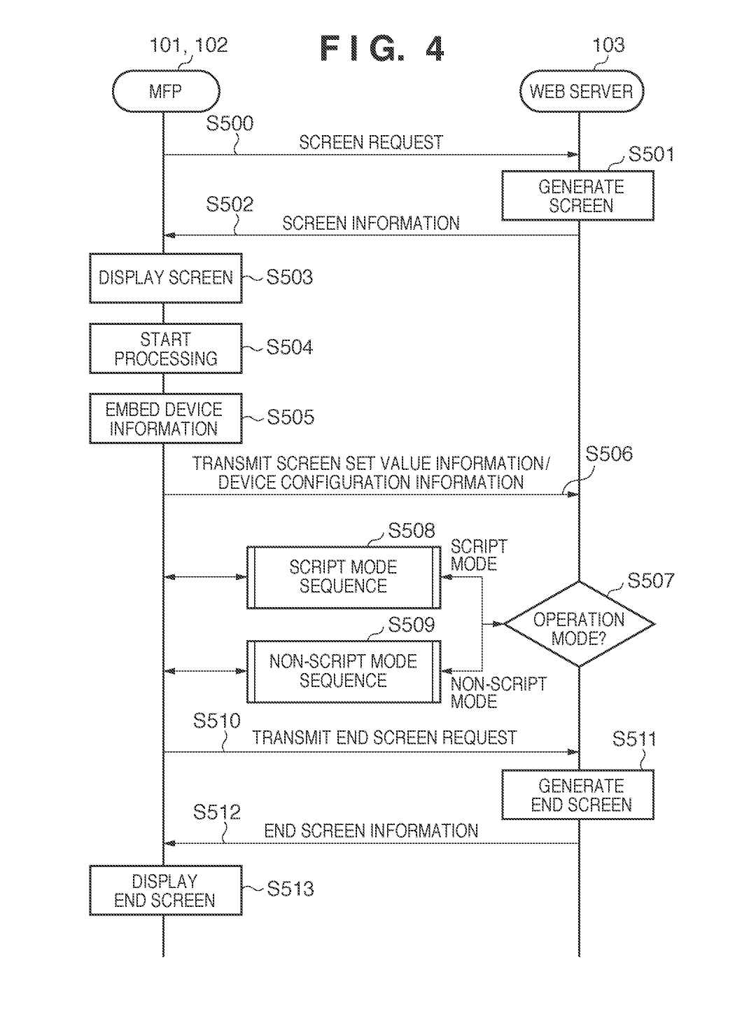

The processing sequence between the MFPs 101 and 102 and the Web server 103 will be described next with reference to FIG. 4. Note that although the description to be made below using FIG. 4 concerns the MFP 101, this also applies to the MFP 102. First, in step S500, the request processing unit 407 in the Web browser 401 requests screen information to be displayed on the display unit 408 of the Web server 103 via the communication unit 406. Upon receiving the request via the communication unit 419, the presentation unit 420 generates screen information (HTML data) to be displayed on the display unit 408 of the MFP in step S501. In step S502, the Web server 103 transmits the screen information generated in step S501 to the Web browser 401. The screen information is analyzed by the request processing unit 407 in the Web browser 401 and displayed on the display unit 408 in step S503.

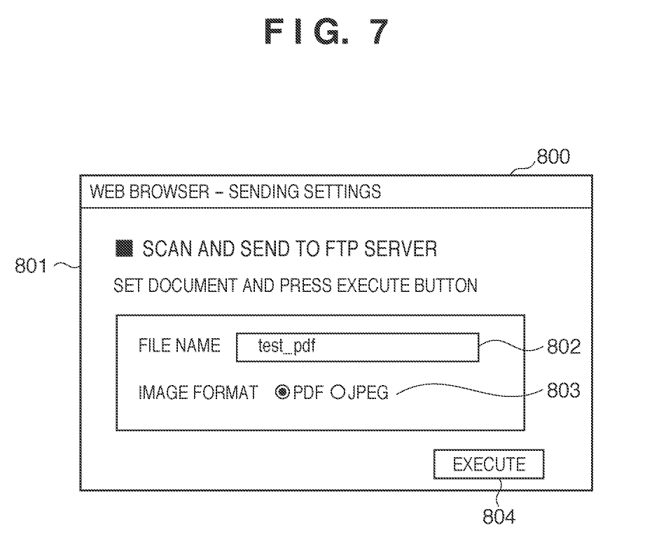

FIG. 7 illustrates an example of the screen displayed on the display unit 408 in step S503. A screen 800 shown in FIG. 7 indicates a GUI (Graphical User Interface) having a function of causing the MFP to scan a paper document and transmit electronic data obtained by scanning to an FTP server on the network. A GUI panel 801 displays a text box 802 to be used to set the file name, and a radio button 803 to be used to select the image format. In this illustrated state, settings are done to give a file name “test.pdf” to image data obtained upon scanning and generate the image data in the PDF format. A GUI button 804 is used to instruct execution of the function. The user presses this button to instruct to start the processing.

Referring back to FIG. 4, when the user presses the GUI button 804, the request processing unit 407 starts the processing in step S504. In step S505, the request processing unit 407 acquires the current device configuration information of the MFP from the device information management unit 405 and embeds the device configuration information (device information) in the HTTP header. The pieces of device information represent the operation capabilities of the MFP and include, for example, information representing whether the MFP can execute a script generated by the Web server 103. After that, in step S506, the communication unit 406 notifies the Web application 418 of the parameters set in the text box 802 and the radio button 803. Note that such communication is done using, for example, the POST command of the HTTP protocol. An example of the device configuration information embedded in the HTTP header in step S506 will be described here.

<Example of Http Header Sent from MFP 102>

GET/ui.html HTTP/1.1

Accept:image/gif,image/jpeg,*/*

Accept-Language:ja

User-Agent:MFP102

Host:127.0.0.1

MFP-ScriptEngineInstalled:true

MFP-ScriptEngineVersion:1.0

MFP-AllowedMemory:512

This is an example of the HTTP header sent from the MFP 102.

<Example of Http Header Sent from MFP 101>

GET/ui.html HTTP/1.1

Accept:image/gif,image/jpeg,*/*

Accept-Language:ja

User-Agent:MFP101

Host:127.0.0.2

MFP-ScriptEngineInstalled:false

This is an example of the HTTP header sent from the MFP 101.

“User-Agent” is the device configuration information representing the identifier of the MFP. “MFP-ScriptEngineInstalled” is the device configuration information representing whether the script processing unit 410 capable of executing a job script exists in the MFP. “MFP-ScriptEngineVersion” is the device configuration information representing the version of the script processing unit 410. “MFP-AllowedMemory” is the device configuration information representing the memory capacity usable in the job script processing of the MFP.

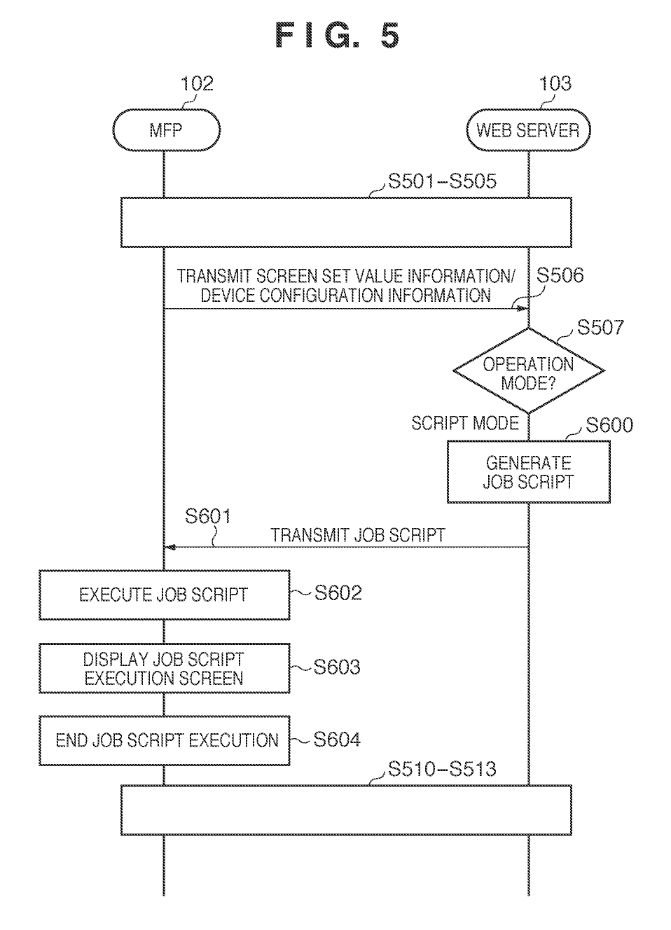

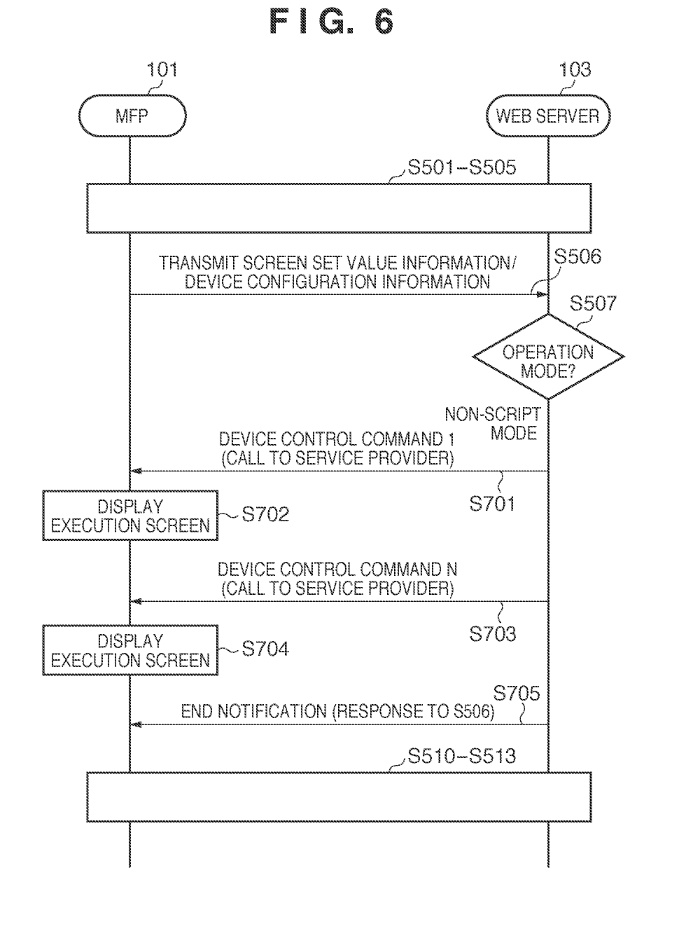

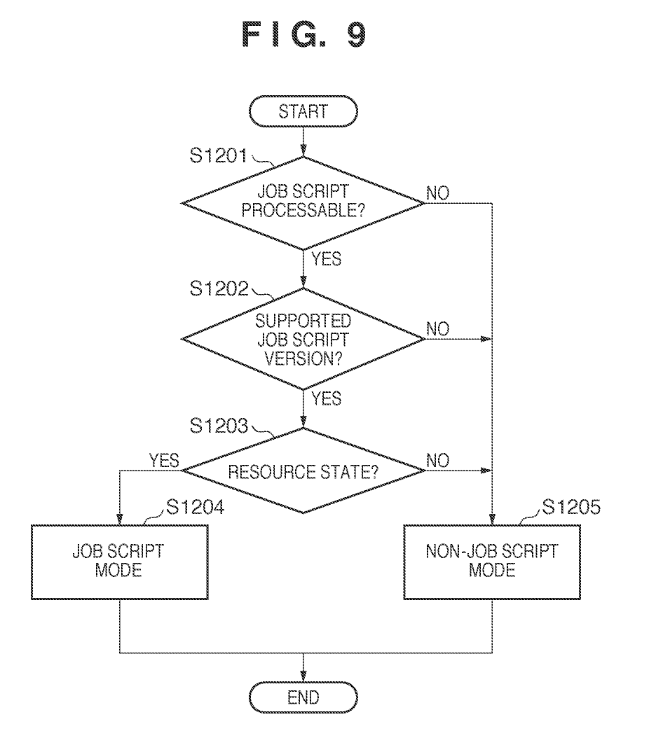

Referring back to FIG. 4, upon receiving the HTTP command in step S506, the presentation unit 420 of the Web server 103 judges, in step S507, the operation mode based on the device configuration information set in step S506. Upon judging in step S507 that the subsequent operation mode (job execution sequence) is the above-described script mode, the process advances to the processing sequence of step S508. Upon judging that the operation mode is the non-script mode, the process advances to the processing sequence of step S509. Note that details of the script mode sequence corresponding to step S508 are illustrated in FIG. 5, and details of the non-script sequence processing corresponding to step S509 are illustrated in FIG. 6. In addition, details of operation mode determination in step S507 are illustrated in the flowchart of FIG. 9.

The operation mode determination processing will be described in detail with reference to FIG. 9. The processing to be described below is implemented by causing the CPU 301 of the Web server 103 to execute, on the RAM 303, control programs read out from the ROM 302, the HDD 304, and the like.

In step S1201, the presentation unit 420 determines whether there is the script processing unit 410 that allows the MFP to execute a job script. This judgment is done by referring to “MFP-ScriptEngineInstalled” of the HTTP header. If this information is true, the process advances to step S1202. If false, the process advances to step S1205.

In step S1202, the presentation unit 420 refers to the version of job scripts process able by the MFP, thereby judging whether the MFP can process a job script. This judgment is done by referring to “MFP-ScriptEngineVersion” of the HTTP header. If this information indicates a predetermined version, the process advances to step S1203. Otherwise, the process advances to step S1205.

In step S1203, the presentation unit 420 refers to the resource information of the MFP, thereby judging whether the MFP can process a job script. This judgment is done by referring to “MFP-AllowedMemory” of the HTTP header. In this embodiment, a memory capacity usable when executing a job script is transmitted, as indicated by the above-described HTTP header. However, the present invention is applicable to any other information. If this information indicates a predetermined memory capacity, the process advances to step S1204. Otherwise, the process advances to step S1205.

If job script execution has been determined to be possible in all of steps S1201 to S1203, the presentation unit 420 sets the operation mode to the script mode in step S1204. After that, the script mode sequence processing of step S508 shown in FIG. 4 is executed. On the other hand, if any one of the conditions is not satisfied in the judgment of steps S1201 to S1203, the presentation unit 420 determines in step S1205 that the MFP of interest cannot execute the job script mode, and sets the operation mode to the non-script mode in step S1205. After that, the non-script mode sequence processing of step S509 shown in FIG. 4 is executed.

Note that in FIG. 9, if any one of the conditions is not satisfied in steps S1201 to S1203, the operation mode is set to the non-job script mode in step S1205. For an MFP that does not execute the non-job script mode, error processing may be performed to cancel the processing. The processing of step S1201 to S1203 is an example of the processing of the analyzing unit. That is, the presentation unit 420 analyzes the HTTP header including the device information transmitted from the MFP and performs the judgment of steps S1201 to S1203 based on the analysis result.

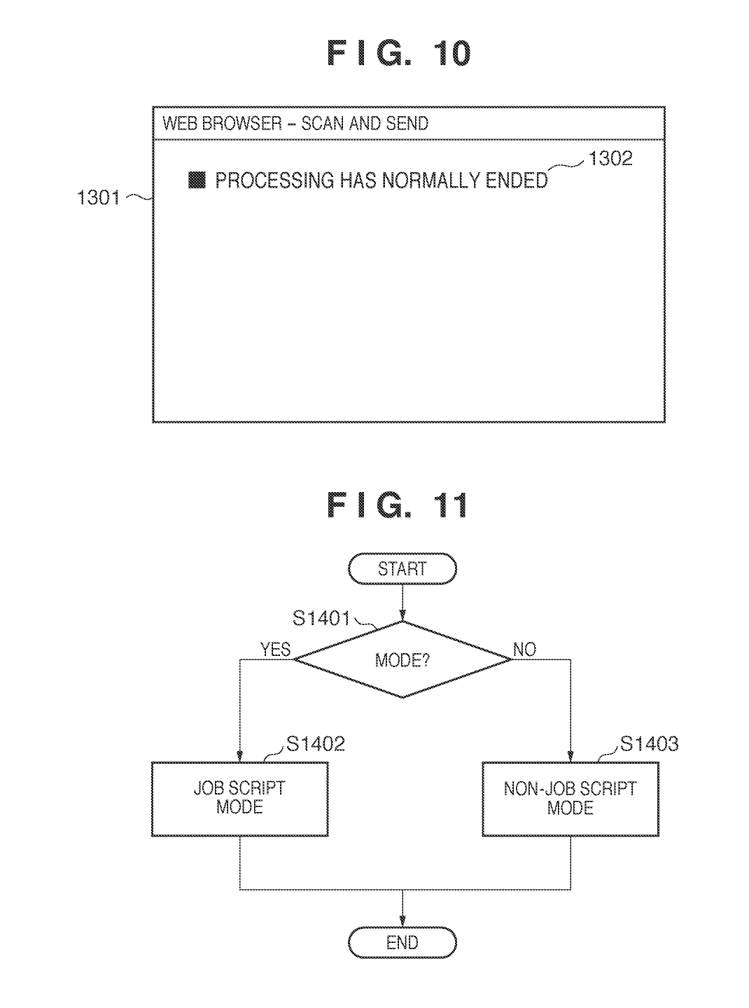

Referring back to FIG. 4, when the job execution sequence of step S508 or S509 has ended, the request processing unit 407 transmits an end screen request to the Web server 103 in step S510. Upon receiving the request, the presentation unit 420 creates the end screen in step S511 and transmits the end screen information to the request processing unit 407 in step S512. Upon receiving the end screen information, the request processing unit 407 interprets the end screen information and displays the screen information on the display unit 408 in step S513. FIG. 10 shows an example of the end screen displayed in step S513. Reference numeral 1301 denotes a GUI displayed on the display unit 408; and 1302, information representing the normal end of the processing.

<Script Mode>

The processing sequence when the MFP 102 requests a screen, and the Web server 103 executes the script mode of step S508 in FIG. 4 will be described next with reference to FIG. 5. That is, the processing to be described below is the operation sequence to be executed when the Web server 103 has determined in step S507 to operate in the job script mode. Note that steps S501 to S505 and S510 to S513 of FIG. 5 are the same as those of FIG. 4, and a description thereof will be omitted.

In step S506, the request processing unit 416 transmits the screen set value information shown in FIG. 7 and the device configuration information to the Web server 103. HTTP header information including the device configuration information in step S506 corresponds to the above-described example of the HTTP header sent from the MFP 102. Subsequently, in step S507, the presentation unit 420 determines the operation mode using the received HTTP header. This will be described more specifically with reference to the flowchart of FIG. 9. In step S1201, since MFP-ScriptEngineInstalled is true, it is determined that the MFP 102 includes the script processing unit. In step S1202, it is determined based on the information of MFP-ScriptEngineVersion (1.0 in this case) that a job script capable of implementing the sequence can be sent. In step S1203, it is determined based on the information of MFP-AllowedMemory that the MFP 102 has a memory capacity that allows job script execution. Hence, the process advances to step S1204, and the presentation unit 420 sets the operation mode to the script mode.

Referring back to FIG. 5, the logic unit 421 of the Web server 103 creates a job script in step S600 and transmits it to the request processing unit 416 in step S601. The following is an example of the job script. The job script below implements the GUI function shown in FIG. 7. That is, the job script includes screen information to display the screen shown in FIG. 7.

<Example of Job Script>

```
<?xml version=“1.0” encoding=“UTF-8”?>
<JobScript xmlns=“http://www.canon.com/jobScript”>
  <Scan>
    <Settings>
      <DocumentSize>AUTO</DocumentSize>
        <ColorMode>GRAY_SCALE</ColorMode>
    </Settings>
  </Scan>
  <Send>
    <Settings>
      <FTPAddress>ftpserver.xxx.com</FTPAddress>
      <FileFormat>PDF</FileFormat>
      <FileName>test.pdf</FileName>
    </Settings>
  </Send>
</JobScript>
```

This job script executes a scan job and a transmission job in order. In this case, the script is expressed by XML. However, the format of the script is not particularly limited if the MFP 102 can process it.

The “JobScript” tag indicates that the job sequence described in the tag should be executed. The “JobScript” tag incorporates the “Scan” tag and the “Send” tag, indicating that these processes should be executed. The “Scan” tag is setting information about the scan job to be executed in the script processing. The “DocumentSize” tag represents that the scan document size should be determined by automatic judgment (“Auto”) of the scanner unit 203. The “ColorMode” tag indicates that the color mode is grayscale (“GRAY_SCALE”).

The “Send” tag is setting information about the transmission job to be executed in the job script. In this job script, the “FTPAddress” tag indicates transmission to the server “ftpserver.xxx.com” using the FTP protocol. The “FileFormat” tag indicates that the format of the file to be transmitted is PDF. The “FileName” tag represents that the name of the file to be transmitted is “test.pdf”. The job script as described above is created by the logic unit 421 of the Web application 418 in step S600 and transmitted to the Web browser 409 in step S601.

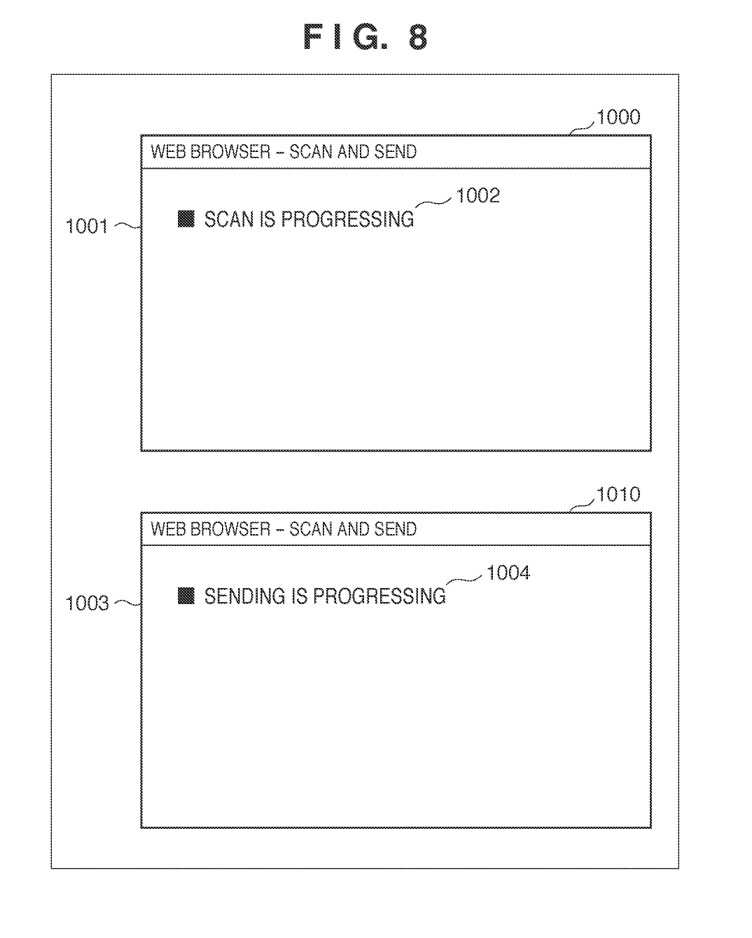

Referring back to FIG. 5, upon receiving the job script, the request processing unit 416 requests the script processing unit 410 to process the job script, and the script processing unit 410 executes the job script in step S602. When executing the job script, the script processing unit 410 displays a job script execution screen on the display unit 417 in step S603. FIG. 8 illustrates an example of the job script execution screen displayed in step S603. Reference numeral 1000 denotes an execution screen when executing the scan job in the job script; 1010, an execution screen when executing the transmission job in the job script; 1001 and 1003, GUI panels; and 1002 and 1004, execution states. Note that in this embodiment, the job script execution screen is displayed on the display unit 417 by the script processing unit 410. However, like the initial screen shown in FIG. 7, the Web server 103 may be requested to create the job script execution screen information.

The job script execution in step S602 is done via the scanner control unit 412 or the printer control unit 411. For example, when executing the above-described job script, the scan command is executed by the scanner control unit 412, and the transmission command is implemented by causing the script processing unit 410 to transmit scan data after the scan command execution to a file server (not shown) via the communication unit 414.

When the job script has ended in step S604, the request processing unit 416 transmits an end screen request to the Web server 103 in step S510. The presentation unit 420 creates the end screen in step S511 and transmits it in step S512. After that, in step S513, the request processing unit 416 receives the end screen and displays it on the display unit 417. Note that FIG. 10 shows an example of the end screen. Reference numeral 1301 denotes a GUI panel; and 1302, display of end information.

<Non-Script Mode>

The processing sequence when the MFP 101 requests a screen, and the Web server 103 executes the non-script mode of step S509 in FIG. 4 will be described next with reference to FIG. 6. That is, the processing to be described below is the operation sequence to be executed when the Web server 103 has determined in step S507 to operate in the non-job script mode. Note that steps S501 to S505 and S510 to S513 of FIG. 6 are the same as those of FIG. 4, and a description thereof will be omitted.

In step S506, the request processing unit 407 transmits the screen set value information shown in FIG. 7 and the device configuration information to the Web server 103. HTTP header information including the device configuration information in step S506 corresponds to the above-described example of the HTTP header sent from the MFP 101. Subsequently, in step S507, the presentation unit 420 determines the operation mode using the received HTTP header. This will be described more specifically with reference to the flowchart of FIG. 9. In step S1201, since MFP-ScriptEngineInstalled is false, it is determined that the MFP 101 includes no script processing unit. Hence, the process advances to step S1205, and the presentation unit 420 sets the operation mode to the non-script mode.

Upon judging in step S507 that the operation mode is the non-script mode, the logic unit 421 issues device control command 1 to the service provider 402 in step S701. Note that the device control commands in steps S701 and S703 can be implemented by a network connection independent of the screen information acquisition processing in steps S501, S502, S506, S705, and the like using a protocol such as SOAP (Simple Object Access Protocol). Device control command 1 in step S701 is, for example, a scan command corresponding to the command of the Scan tag of the job script in the above-described script mode.

Upon receiving device control command 1, the service provider 402 displays the execution screen 1000 shown in FIG. 8 on the display unit 408 in step S702. Next, in step S703, the logic unit 421 issues device control command N to the service provider 402. Device control command N in step S703 is, for example, a transmission command corresponding to the command of the Send tag of the job script in the above-described script mode. Upon receiving device control command N, the service provider 402 displays the execution screen on the display unit 408 in step S704. The execution screen 1010 shown in FIG. 8 is displayed on the display unit 408. The device control commands are transmitted one by one in accordance with the executed job sequence, as indicated by steps S701 and S703. In addition, the device control command can incorporate a plurality of commands, for example, a scan command and a transmission command.

When all device control commands have ended, the logic unit 421 transmits a job sequence end notification to the Web browser 409 in step S705. Upon receiving the end notification in step S705, the request processing unit 407 transmits an end screen request to the Web server 103 in step S510. The presentation unit 420 creates the end screen in step S511 and transmits it in step S512. In step S513, the request processing unit 407 receives the end screen and displays it on the display unit 408. Note that the screen shown in FIG. 10 is displayed on the display unit 408 as the end screen, as in the script mode.

As described above, the information processing system according to this embodiment includes an MFP capable of executing a job script, an MFP that opens the functions of the MFP to the outside so as to allow controlling job execution externally, and a Web server that creates screen data to be displayed on the operation unit of the MFP. According to the embodiment, this information processing system causes the MFP to notify the Web server of the device configuration information of the MFP and allows the Web server to determine, based on the device configuration information, the optimum operation mode when causing the MFP to execute a job.

### Second Embodiment

The second embodiment of the present invention will be explained next mainly concerning a technique and arrangement different from the first embodiment. As for the information processing system according to the first embodiment, an example has been described in which the MFP notifies the Web server of the device configuration information, and the Web server determines, based on the device configuration information, the optimum operation mode when causing the MFP to execute a job. In the second embodiment, however, an example will be described in which an MFP determines the operation mode of a Web server, and a job sequence is executed in that operation mode. In this embodiment, the MFP sends the following HTTP header to a Web server 103 in step S506 of FIG. 4.

<Example of HTTP Header Sent from MFP 102>

GET/ui.html HTTP/1.1

Accept:image/gif,image/jpeg,*/*

Accept-Language:ja

User-Agent:MFP102

Host:127.0.0.1

MFP-JobSequence:Script

This is an example of the HTTP header sent from the MFP 102.

<Example of HTTP Header Sent from MFP 101>

GET/ui.html HTTP/1.1

Accept:image/gif,image/jpeg,*/*

Accept-Language:ja

User-Agent:MFP101

Host:127.0.0.2

MFP-JobSequence:NonScript

This is an example of the HTTP header sent from the MFP 101.

These HTTP headers represent device configuration information sent from the MFPs 101 and 102. The item “MFP-JobSequence” indicates the operation mode in which the MFP operates. When Script is set in MFP-JobSequence, the MFP operates in the script mode (“Script”). When NonScript is set, the MFP operates in the non-script mode (“NonScript”). Hence, according to this embodiment, a communication unit 406 transmits device configuration information (HTTP header) including the information of the determined operation mode to the Web server 103 in step S506 of FIG. 4.

The processing procedure when the Web server 103 according to this embodiment determines the operation mode in step S507 will be described next with reference to FIG. 11. The processing to be described below is implemented by causing a CPU 301 of the Web server 103 to execute, on a RAM 303, control programs read out from a ROM 302, an HDD 304, and the like.

In step S1401, a presentation unit 420 determines the operation mode by referring to the information “MFP-JobSequence” of the HTTP header received from the MFP 101 or 102. Hence, when the HTTP header of the MFP 102 is received, the process advances to step S1402, and the presentation unit 420 sets the operation mode to the script mode. On the other hand, when the HTTP header of the MFP 101 is received, the process advances to step S1403, and the operation mode is set to the non-script mode.

As described above, in this embodiment, the device configuration information to be transmitted by the MFP includes information representing the operation mode (for example, the script mode or the non-script mode). The Web server causes the MFP to execute a job in the operation mode complying with the information.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-139942 filed on Jun. 18, 2010, which is hereby incorporated by reference herein in its entirety.

What is claimed is:

1. An information processing system including an image processing apparatus and an information processing apparatus which are connected via a network,
said image processing apparatus comprising:
a generation unit that generates device information representing an operation capability of said image processing apparatus; and
a device information transmission unit that transmits the device information generated by said generation unit to said information processing apparatus, and
said information processing apparatus comprising:
an analyzing unit that analyzes the device information transmitted from said image processing apparatus; and
a determination unit that determines, based on an analysis result of said analyzing unit, an operation mode when causing said image processing apparatus to execute a job.

2. The system according to claim 1, wherein
the device information includes information representing, as the operation capability of said image processing apparatus, whether it is possible to execute a script generated by said information processing apparatus and defining a processing procedure of a job that executes at least one function of said image processing apparatus, and
said determination unit determines the operation mode to be a script mode in which the job is executed using the script if the device information represents that execution of the script is possible, and determines the operation mode to be a non-script mode in which the job is executed without using the script if the device information represents that execution of the script is impossible.

3. The system according to claim 2, wherein if the device information represents that said image processing apparatus includes a unit that executes the script, said unit can execute a script of a predetermined version, said image processing apparatus has a predetermined memory capacity, and said determination unit judges that execution of the script is possible and determines the operation mode to be the script mode.

4. The system according to claim 2, wherein
said information processing apparatus further comprises a script transmission unit that, when causing said image processing apparatus to execute a job in the script mode, transmits a script to execute the job, and
said image processing apparatus further comprises an execution unit that executes the job in accordance with the script transmitted from said information processing apparatus.

5. The system according to claim 2, wherein
said information processing apparatus further comprises a command transmission unit that, when causing said image processing apparatus to execute a job in the script mode, transmits at least one command to execute the job on a one-by-one basis, and
said image processing apparatus further comprises an execution unit that executes the job in accordance with the command transmitted from said information processing apparatus.

6. An information processing system including an image processing apparatus and an information processing apparatus which are connected via a network,
said image processing apparatus comprising:
an analyzing unit that analyzes an operation capability of said image processing apparatus;
a determination unit that determines, based on an analysis result of said analyzing unit, an operation mode when executing a job designated by said information processing apparatus; and
an operation mode transmission unit that transmits the operation mode determined by said determination unit to said information processing apparatus.

7. A method of controlling an information processing system including an image processing apparatus and an information processing apparatus which are connected via a network, comprising:
causing a generation unit of the image processing apparatus to generate device information representing an operation capability of the image processing apparatus;
causing a device information transmission unit of the image processing apparatus to transmit the device information generated in causing the generation unit of the image processing apparatus to generate the device information to the information processing apparatus;
causing an analyzing unit of the information processing apparatus to analyze the device information transmitted from the image processing apparatus; and
causing a determination unit of the information processing apparatus to determine, based on an analysis result of causing the analyzing unit of the information processing apparatus to analyze the device information, an operation mode when causing the image processing apparatus to execute a job.

8. A method of controlling an information processing system including an image processing apparatus and an information processing apparatus which are connected via a network, comprising:
causing an analyzing unit of the image processing apparatus to analyze an operation capability of the image processing apparatus;
causing a determination unit of the image processing apparatus to determine, based on an analysis result of causing the analyzing unit of the image processing apparatus to analyze the operation capability, an operation mode when executing a job designated by the information processing apparatus; and
causing an operation mode transmission unit of the image processing apparatus to transmit the operation mode determined in causing the determination unit of the image processing apparatus to determine the operation mode to the information processing apparatus.

9. A computer-readable storage medium storing a computer program which causes a computer to execute an information processing system control method of claim 7.

10. A computer-readable storage medium storing a computer program which causes a computer to execute an information processing system control method of claim 8.
